(19) United States
(12) Patent Application Publication
(10) Pub. No.: US 2026/0266329 A1
(43) Pub. Date: Sep. 10, 2026

(54) FASTENER

(71) Applicant: YKK CORPORATION, Chiyoda-ku, Tokyo (JP)

(72) Inventor: Kenichi YOSHIE, Kurobe-shi, Toyama (JP)

(21) Appl. No.: 19/107,995

(22) PCT Filed: Aug. 31, 2022
(86) PCT No.: PCT/JP2022/032768

§ 371 Date: Feb. 28, 2025

(51) Int. Cl. F16B 45/02; F16B 45/00

(52) U.S. Cl. CPC F16B 45/023; F16B 45/008; F16B 45/024

(57) ABSTRACT

A connector is made of synthetic resin, integrally includes a base having a tape through hole, a hook configured to form an accommodation space having an opening for passing an article, an opening and closing body rotatably supported on the base and configured to open the opening when rotated in one direction and to close the opening when rotated in another direction, and a spring portion configured to constantly bias the opening and closing body in a direction in which the opening and closing body closes the opening. The spring portion extends from the base and is continuous with the opening and closing body. The opening and closing body includes a shaft portion. The base has a shaft hole into which the shaft portion is to be rotatably fitted.

### TECHNICAL FIELD

The present invention relates to a connector for connecting separate articles or parts to each other.

### BACKGROUND ART

In the related art, connectors for connecting a pair of articles have various shapes. For example, a hook in Patent Literature 1 includes an annular member having a substantially annular shape and a case member into which the annular member is inserted. A lever portion is formed on the annular member, part of which is cut and is capable of swinging elastically, and the object to be locked can be inserted into the interior through an opening and closing portion that opens and closes due to the elastic swing of the lever portion. In a state in which the annular member is inserted into the case member, the case member abuts against the lever portion to restrict outward opening of the lever portion.

### CITATION LIST

### Patent Literature

Patent Literature 1: JP2009-2389A

### SUMMARY OF INVENTION

### Technical Problem

The connector in the background art described above includes two members which are the annular member and the case member, and is costly to manufacture. When a pair of articles are connected, one article is attached to the annular member and another article is attached to the case member. Therefore, if strong forces are applied to the articles in directions in which the articles move away from each other, the annular member and the case member may come off each other. Further, the locking portion to which the distal end of the lever portion is locked is not locked in the direction in which the tension is applied by the pair of articles. Therefore, the tension applied between the pair of articles may be concentrated on one side of the annular member, and the annular member may be deformed or broken.

The present invention has been made in view of the problems in the background art described above, and an object of the present invention is to provide a connector that is made of a single member to simplify the component configuration and reduce the manufacturing cost, and that has high strength for attaching an article.

### Solution to Problem

The present invention provides a connector made of a synthetic resin, integrally including a base having a tape through hole, a hook configured to form an accommodation space having an opening for passing an article, an opening and closing body rotatably supported on the base and configured to open the opening when rotated in one direction and to close the opening when rotated in another direction, and a spring portion configured to constantly bias the opening and closing body in a direction in which the opening and closing body closes the opening, in which the spring portion extends from a side edge portion of the base and is continuous with the opening and closing body, in which the opening and closing body includes a shaft portion, and in which the base has a shaft hole into which the shaft portion is to be rotatably fitted.

The base is a plate-shaped body, the tape through hole and the accommodation space penetrate the plate-shaped body, and the base has a groove along the side edge portion of the base, and in a state in which the shaft portion is fitted into the shaft hole, at least a part of the spring portion is accommodated in the groove.

One of the opening and closing body and the hook includes a hook portion, and another of the hook and the opening and closing body includes a hook portion accommodation portion, and the hook portion is inserted into the hook portion accommodation portion in a state in which the opening is closed by the opening and closing body.

The tape through hole is formed between the opening and the shaft hole, and a recess is formed in the opening and closing body, the recess overlapping with the tape through hole in a state in which the opening and closing body is rotated in a direction in which the opening is opened. The shaft hole is preferably formed at a position covered by a tape passed through the tape through hole.

### Advantageous Effects of Invention

The connector according to the present invention has a simple component configuration and a low manufacturing cost. The connector has a sleek appearance and looks small, but has high strength for attaching an article. Further, the opening operation of the opening and closing body is light, and the operability is good.

### BRIEF DESCRIPTION OF DRAWINGS

FIG. 1 is a perspective view of a connector according to an embodiment of the present invention.

FIG. 2A is a left side view of the connector according to the embodiment.

FIG. 2B is a front view of the connector according to the embodiment.

FIG. 3 is a longitudinal cross-sectional view taken along a line A-A in FIG. 2A, showing a state in which no force is applied to a spring portion of the connector according to the embodiment.

FIG. 4 is a longitudinal cross-sectional view taken along a line B-B in FIG. 2A, in which the spring portion of the connector according to the embodiment is pressed and used.

FIG. 5 is a longitudinal cross-sectional view taken along the line B-B in FIG. 2A, showing a state in which the opening of the connector according to the embodiment is open.

FIG. 6 is a front view showing a modification of the connector according to the embodiment.

FIG. 7 is a longitudinal cross-sectional view showing another modification of the connector according to the embodiment.

### DESCRIPTION OF EMBODIMENTS

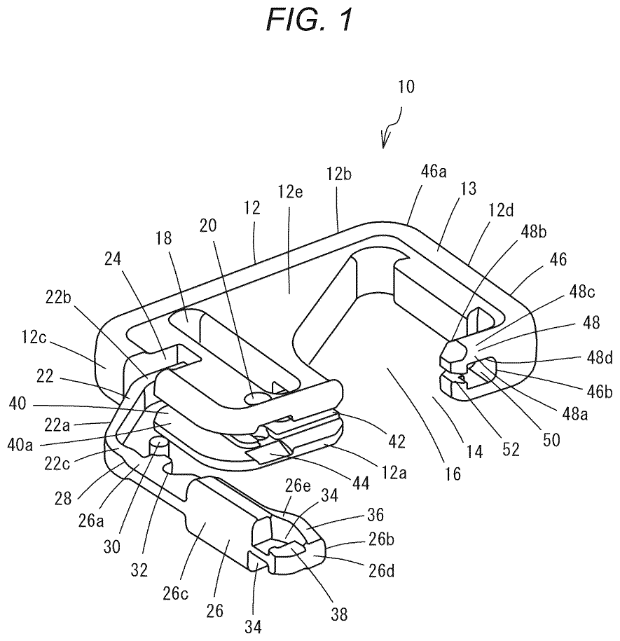

Hereinafter, an embodiment of the present invention will be described with reference to the drawings. FIGS. 1 to 5 show an embodiment of the present invention, and a connector 10 according to the embodiment is integrally molded using an elastic synthetic resin.

The connector 10 includes a plate-shaped base 12. The base 12 includes a pair of side edge portions 12a and 12b that extend in the upper-lower direction, and a pair of side edge portions 12c and 12d that extend in the left-right direction and that intersect the side edge portions 12a and 12b. Both surfaces of the base 12 are symmetrical with respect to the center in the front-rear direction as a central axis. Hereinafter, a direction orthogonal to both surfaces of the plate-shaped body is referred to as the front-rear direction. A direction along the pair of side edge portions 12a and 12b is referred to as the upper-lower direction. A direction along the pair of side edge portions 12c and 12d is referred to as the left-right direction. The pair of side edge portions 12c and 12d are substantially parallel to each other, and the side edge portion 12d is longer than the side edge portion 12c. The base 12 includes a plate surface portion 12e that is surrounded by the side edge portions 12a, 12b, 12c, and 12d, and a thick portion 13 that protrudes along the side edge portions 12a, 12b, 12c, and 12d in the front-rear direction. The thick portion 13 has a substantially constant width and is thicker than the plate surface portion 12e.

An accommodation space 16 is formed in the plate surface portion 12e so as to penetrate the plate surface portion 12e in the front-rear direction. The accommodation space 16 has a trapezoidal shape in which a side located close to the side edge portion 12c is the upper side and a side located close to the side edge portion 12d is the lower side. The upper side is shorter than the lower side. One end portion of the upper side reaches the side edge portion 12a, and another end portion of the upper side is located near the center of the base 12 in the left-right direction. The oblique side that connects the end portion of the upper side located near the center of the base 12 and the end portion of the lower side on the side edge portion 12b side intersects the upper side at an obtuse angle and intersects the lower side at an acute angle. An opening 14 is cut out at the side edge portion 12a and at the side opposite to the oblique side of the accommodation space 16. Accordingly, the accommodation space 16 and the outside of the side edge portion 12a communicate with each other. The end portion of the opening 14 on the side edge portion 12d side is located slightly away from the side edge portion 12d. That is, a portion of the side edge portion 12a that is continuous with the side edge portion 12d is left uncut. This portion serves as a distal end portion 46b of a hook 46 to be described later.

The base 12 has a tape through hole 18 that extends substantially parallel to the side edge portion 12c between the upper side of the accommodation space 16 and the side edge portion 12c. A shaft hole 20 is formed between the tape through hole 18 and the side edge portion 12c, that is, on the opposite side to the accommodation space 16 across the tape through hole 18 and at a position close to the side edge portion 12a. A shaft portion 30 to be described later is rotatably fitted into the shaft hole 20. The tape through hole 18 and the shaft hole 20 penetrate the plate surface portion 12e in the front-rear direction.

A spring portion 22 is provided integrally and continuously with the base 12. The spring portion 22 is a long rod-shaped body, and one end portion of the spring portion 22 in the length direction is connected to the base 12. The spring portion 22 is elastically deformable in a direction intersecting the front-rear direction of the base 12 when a force equal to or greater than a certain level is applied thereto.

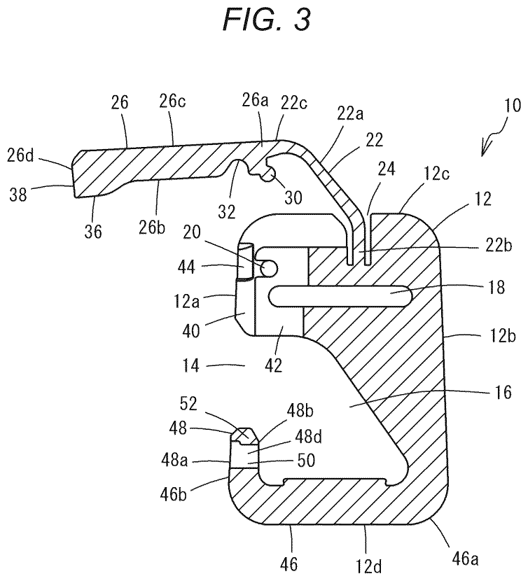

As shown in FIG. 3, the spring portion 22 includes a first portion 22a that is located in the intermediate portion in the length direction, a second portion 22b that is continuous from one end portion of the first portion 22a and that is bent toward the first portion 22a, and a third portion 22c that is continuous from another end portion of the first portion 22a and that is bent toward the first portion 22a. The second portion 22b is continuous with the base 12 on the side edge portion 12c side. The base 12 has a space 24 that is recessed in the upper-lower direction on the side edge portion 12c side. The second portion 22b is provided in the space 24. The second portion 22b can be freely deformed in the space 24. The first portion 22a extends toward the side edge portion 12a while being inclined in a direction away from the side edge portion 12c. The third portion 22c is provided at a predetermined interval from the side edge portion 12c. The boundary between the first portion 22a and the second portion 22b and the boundary between the first portion 22a and the third portion 22c are curved. In a state in which no force is applied, the spring portion 22 has a shape of extending outward from the side edge portion 12c as shown in FIGS. 1 and 3.

An opening and closing body 26 that opens and closes the opening 14 is integrally continuous with the end portion of the third portion 22c of the spring portion 22. The opening and closing body 26 is a rod-shaped body that is elongated in the extending direction of the third portion 22c. The opening and closing body 26 includes a base end portion 26a that is continuous with the third portion 22c of the spring portion 22, and a distal end portion 26d that is located on the opposite side of the opening and closing body 26 with respect to the base end portion 26a in the length direction. The opening and closing body 26 has an outer side surface 26c that is flush with and continuous with the third portion 22c of the spring portion 22 and that extends in the length direction of the opening and closing body 26, and an inner side surface 26b that is located on the side opposite to the outer side surface 26c.

The opening and closing body 26 has a length that can close the opening 14. A region on the base end portion 26a side from the intermediate portion of the opening and closing body 26 in the length direction is thinner than the thickness of the thick portion 13 of the base 12. A region from the intermediate portion of the opening and closing body 26 in the length direction toward the distal end portion 26d includes a portion on the outer side surface 26c side and a portion on the inner side surface 26b side that have different thicknesses. The portion on the outer side surface 26c side is thicker than the portion on the inner side surface 26b side, and has substantially the same thickness as the thick portion 13 of the base 12. The portion on the inner side surface 26b side is thinner than the portion on the outer side surface 26c side, and is thicker than the region on the base end portion 26a side. The dimension in the width direction orthogonal to the length direction and the thickness direction of the opening and closing body 26, that is, the distance between the inner side surface 26b and the outer side surface 26c is larger than the dimension in the direction orthogonal to the length direction and the thickness direction of the third portion 22c. Accordingly, a portion of the opening and closing body 26 on the inner side surface 26b side protrudes inward of the third portion 22c. A part of the portion on the inner side surface 26b side that is continuous with the distal end portion 26d protrudes further inward. The thickness direction of the opening and closing body 26 is the same direction as the front-rear direction of the base 12.

The opening and closing body 26 includes the shaft portion 30 at the base end portion 26a. The shaft portion 30 has a cylindrical shape having a central axis parallel to the thickness direction of the base 12, and protrudes from the opening and closing body 26 in the thickness direction. The shaft portion 30 is rotatably fitted into the shaft hole 20 of the base 12.

The opening and closing body 26 has a recess 32 that communicates with the tape through hole 18 at the base end portion 26a. The recess 32 has a U shape that opens toward the inner side surface 26b. The recess 32 is formed in a shape that substantially matches the hole edge of the tape through hole 18 or is larger than the hole edge of the tape through hole 18 when the opening and closing body 26 rotates in the direction in which the opening 14 is opened. Accordingly, the opening and closing body 26 and the tape through hole 18 overlap with each other, and a part of the tape through hole 18 is prevented from being blocked by the opening and closing body 26.

The opening and closing body 26 has locking recesses 34 at the distal end portion 26d, the thickness of which is reduced in the thickness direction. The pair of locking recesses 34 are symmetrically arranged in the thickness direction of the opening and closing body 26. The locking recess 34 is cut out so as to open toward the outer side surface 26c. The uncut portion between the locking recess 34 and the inner side surface 26b becomes an abutment portion 36 that can abut against an engagement claw 48 to be described later from the accommodation space 16 side when the opening and closing body 26 closes the opening 14. The opening and closing body 26 includes a hook portion 38 that is provided adjacent to the locking recess 34. The hook portion 38 is connected to the abutment portion 36 and extends toward the outer side surface 26c.

The base 12 has a groove 40 along substantially the center line of the thickness of the base 12 at a portion where the side edge portion 12a and the side edge portion 12c intersect and between a position where the spring portion 22 is connected to the base 12 and the opening 14. As shown in FIGS. 1 and 3, the groove 40 has a portion that communicates from the space 24 for deformation to the side edge portion 12c and a portion that communicates from the side edge portion 12a to the opening 14. Accordingly, the groove 40 forms an L-shaped space. The groove 40 also communicates with the shaft hole 20, the side edge portion 12a side portion of the tape through hole 18, and the accommodation space 16. The groove 40 has a pair of inner side surfaces 40a that are substantially parallel to the plate surface portion 12e. The inner side surfaces 40a include step portions 42 that protrude in the front-rear direction around the shaft hole 20. The inner side surfaces 40a include inclined surfaces 44 that are inclined in directions away from each other from the shaft hole 20 toward the side edge portion 12a. The step portion 42 and the inclined surface 44 serve as guides for guiding the shaft portion 30 to the shaft hole 20 when the shaft portion 30 of the opening and closing body 26 is fitted into the shaft hole 20 of the base 12.

The base 12 includes the hook 46 that forms the accommodation space 16 at the side edge portion 12d and the side edge portion 12a continuous with the side edge portion 12d. The hook 46 is an L-shaped rod. The hook 46 includes a base end portion 46a that is one end portion in the length direction, and a distal end portion 46b that is opposite to the one end portion. The base end portion 46a is connected to the end portion of the side edge portion 12b. The distal end portion 46b is located on the opening 14 side, and the engagement claw 48 is provided. A pair of engagement claws 48 are provided at an interval in the front-rear direction of the base 12. A space between the engagement claws 48 serves as a hook portion accommodation portion 50 in which the hook portion 38 of the opening and closing body 26 is accommodated and positioned. The engagement claws 48 include protruding portions 52 on the facing surfaces thereof that protrude into the hook portion accommodation portion 50. The opening and closing body 26 may include a hook portion accommodation portion, and the hook 46 may include a hook portion.

The connector 10 according to the embodiment is integrally molded using a synthetic resin having appropriate elasticity. In the molded state, the spring portion 22 and the opening and closing body 26 protrude laterally from the base 12 as shown in FIGS. 1 and 3. When the connector 10 is used, the spring portion 22 is pushed along the side edge portion 12a and the side edge portion 12c of the base 12. Accordingly, the spring portion 22 is accommodated in the groove 40 while being elastically deformed so as to reduce the intersection angle between the first portion 22a and the second portion 22b and the intersection angle between the first portion 22a and the third portion 22c. Then, the shaft portion 30 moves along the inclined surface 44 and the step portion 42. Accordingly, the shaft portion 30 is fitted into the shaft hole 20.

Next, the distal end portion 26d of the opening and closing body 26 is pushed in the front-rear direction and the left-right direction so as not to interfere with the engagement claw 48 of the base 12, and the spring portion 22 is elastically deformed. At this time, the spring portion 22 is elastically deformed in the front-rear direction, and is elastically deformed so as to reduce the intersection angle between the first portion 22a and the second portion 22b of the spring portion 22 and the intersection angle between the first portion 22a and the third portion 22c. Accordingly, the distal end portion 26d avoids the engagement claw 48 and enters the accommodation space 16. Then, when the pressing in the left-right direction is released after the pressing in the front-rear direction is released, the opening and closing body 26 rotates about the shaft portion 30 by the elastic force of the spring portion 22. Accordingly, the hook portion 38 of the opening and closing body 26 is inserted into the hook portion accommodation portion 50 of the distal end portion 46b of the hook 46. Then, the abutment portion 36 comes into contact with the engagement claw 48.

At this time, since the protruding portions 52 of the pair of engagement claws 48 are located in the locking recesses 34 and the hook portions 38 are located in the hook portion accommodation portion 50, the opening and closing body 26 is positioned in the front-rear direction of the base 12. Since the abutment portion 36 is in contact with the engagement claw 48, the opening and closing body 26 is not displaced in the left-right direction orthogonal to the front-rear direction of the base. Since the shaft portion 30 is fitted into the shaft hole 20, the opening and closing body 26 does not move in the upper-lower direction of the base 12.

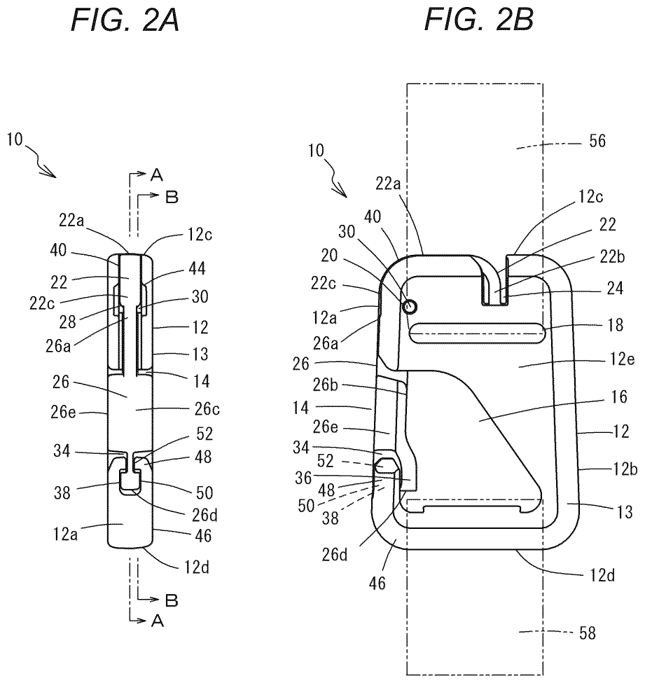

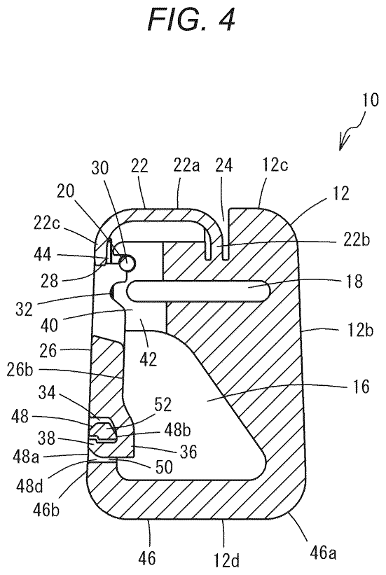

Accordingly, as shown in FIGS. 2A, 2B and 4, the opening and closing body 26 is positioned in the opening 14 of the base 12 and closes the opening 14. That is, the connector 10 is in the use state. The spring portion 22 acts to increase the intersection angle between the first portion 22a and the second portion 22b and the intersection angle between the first portion 22a and the third portion 22c. The elastic force caused by this action causes the distal end portion 26d side of the opening and closing body 26 to rotate around the axis of the shaft portion 30. Accordingly, the abutment portion 36 is constantly pressed against the engagement claw 48. Therefore, the opening and closing body 26 does not come off the hook 46 inadvertently.

Next, a method for using the connector 10 will be described. First, a tape 56 passes through the tape through hole 18. The tape 56 is folded back, and the folded back portion is sewn or fastened by any fastener (not shown). The tape 56 passed through the tape through hole 18 extends in the upper-lower direction beyond the side edge portion 12c of the base 12. Therefore, when the tape 56 has a predetermined dimension in the left-right direction, the tape 56 can cover the shaft hole 20 formed between the tape through hole 18 and the side edge portion 12c and the space 24 recessed on the side edge portion 12c side in the upper-lower direction. Accordingly, the shaft hole 20 and the space 24 are not visually recognized when the connector 10 is used, and the appearance of the connector 10 can be improved when the connector 10 is used.

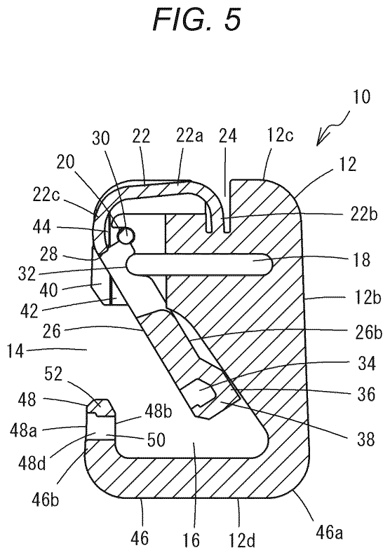

Next, an article 58 is hung from the hook 46. The article 58 is, for example, a loop in which a tape is folded back and fixed, or a hook in the same form as the hook 46. First, as shown in FIG. 5, the opening and closing body 26 is pushed toward the inside of the accommodation space 16. Accordingly, the opening and closing body 26 rotates in one direction about the shaft portion 30 while elastically deforming the spring portion 22. The hook portion 38 is removed from the hook portion accommodation portion 50. As a result, the opening and closing body 26 opens the opening 14, and the article 58 is passed through the opening 14 and is hung from the hook 46. When the pressing force is released, the opening and closing body 26 rotates in another direction opposite to the one direction about the shaft portion 30 by the elastic force of the spring portion 22. As a result, the opening and closing body 26 closes the opening 14. Since the opening and closing body 26 is constantly biased toward the engagement claw 48 by the spring portion 22, the opening 14 is not inadvertently opened. Moreover, since the protruding portion 52 of the engagement claw 48 is located in the locking recess 34 of the opening and closing body 26 and the hook portion 38 is inserted into the hook portion accommodation portion 50, the opening and closing body 26 is locked to the hook 46 in the front-rear direction and the upper-lower direction of the base 12. Accordingly, the opening and closing body 26 does not come off the hook 46 inadvertently.

As shown in FIG. 5, in the opening and closing body 26, in a state in which the opening 14 is opened by the opening and closing body 26, the recess 32 and the hole edge of the tape through hole 18 coincide with each other. Accordingly, the opening and closing body 26 does not overlap with the tape through hole 18, and does not push and displace the tape 56 passed through the tape through hole 18.

When a strong force is applied to the article 58 hung from the hook 46, the distal end portion 46b of the hook 46 is elastically deformed in a direction away from the distal end portion 26d of the opening and closing body 26. At this time, since the hook portion 38 is inserted into the hook portion accommodation portion 50, it is possible to secure a large engagement area between the hook portion 38 and the hook portion accommodation portion 50. Therefore, the opening and closing body 26 and the hook 46 are firmly engaged with each other against the force acting in the upper-lower direction of the base 12.

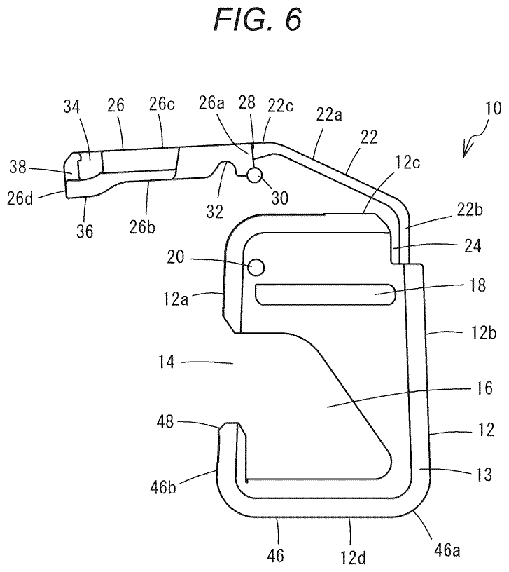

The position where the spring portion 22 is continuous with the base 12 may be other than that in the above embodiment. For example, as shown in FIG. 6, the second portion 22b of the spring portion 22 may be connected to a boundary portion between the side edge portion 12b and the side edge portion 12c of the base 12. The base 12 has the space 24 that is recessed at the boundary between the side edge portion 12b and the side edge portion 12c. The second portion 22b is provided in the space 24. The first portion 22a of the spring portion 22 has substantially the same length as the side edge portion 12c of the base 12.

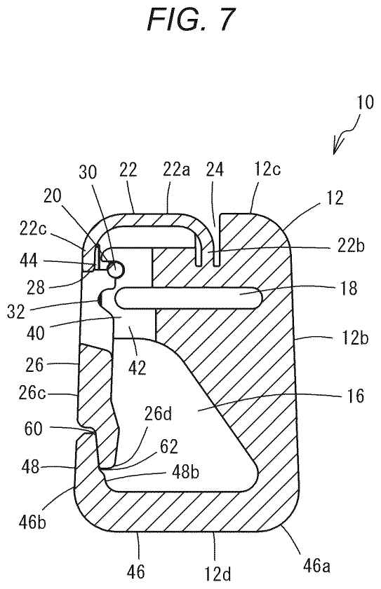

The distal end portion 26d of the opening and closing body 26 may have a simple shape that only abuts against the distal end portion 46b of the hook 46. For example, as shown in FIG. 7, the opening and closing body 26 may not have the locking recess 34, the abutment portion 36, and the hook portion 38 as in the above embodiment. Instead, the opening and closing body 26 has a locking recess 60 on the outer side surface 26c on the distal end portion 26d side. The engagement claw 48 of the hook 46 does not include the hook portion accommodation portion 50 and the protruding portion 52 as in the above embodiment. Instead, the engagement claw 48 has a locking recess 62 in a portion facing the opening and closing body 26. When the opening and closing body 26 closes the opening 14, the locking recess 60 and the locking recess 62 abut against each other.

The connector according to the present invention is not limited to the above embodiment. The shape of the base may be a polygon other than a rectangle, an ellipse, or the like, and can be freely changed. The spring portion can also be changed to match the shape of the base. The article to be connected may be other than a loop or a hook in which the tape is folded back. The type, color, surface treatment, transparency, and the like of the synthetic resin used as the material of the connector can be freely changed, and can be appropriately changed according to the design and the necessary functions.

1. A connector made of synthetic resin, integrally including a base having a tape through hole, a hook configured to form an accommodation space having an opening for passing an article, an opening and closing body rotatably supported on the base and configured to open the opening when rotated in one direction and to close the opening when rotated in another direction, and a spring portion configured to constantly bias the opening and closing body in a direction in which the opening and closing body closes the opening,
wherein the spring portion extends from the base and is continuous with the opening and closing body,
wherein the opening and closing body includes a shaft portion, and
wherein the base has a shaft hole into which the shaft portion is to be rotatably fitted.

2. The connector according to claim 1,
wherein the base is a plate-shaped body, the tape through hole and the accommodation space penetrate the plate-shaped body, and
wherein the base has a groove along a side edge portion, and in a state in which the shaft portion is fitted into the shaft hole, at least a part of the spring portion is accommodated in the groove.

3. The connector according to claim 1,
wherein one of the opening and closing body and the hook includes a hook portion, and another of the hook and the opening and closing body includes a hook portion accommodation portion, and
wherein the hook portion is inserted into the hook portion accommodation portion in a state in which the opening is closed by the opening and closing body.

4. The connector according to claim 1,
wherein the tape through hole is formed between the opening and the shaft hole, and a recess is formed in the opening and closing body, the recess overlapping with the tape through hole in a state in which the opening and closing body is rotated in a direction in which the opening is opened.

5. The connector according to claim 1,
wherein the shaft hole is formed at a position covered by a tape passed through the tape through hole.
